(19) United States
(12) Patent Application Publication
(10) Pub. No.: US 2009/0154793 A1
(43) Pub. Date: Jun. 18, 2009

(54) DIGITAL PHOTOGRAMMETRIC METHOD AND APPARATUS USING INTERGRATED MODELING OF DIFFERENT TYPES OF SENSORS

(75) Inventors: Sung Woong SHIN, Daejeon (KR); Ayman HABIB, Calgary (CA); Mwafag GHANMA, Al-Salt (JO); Changjae KIM, Calgary (CA); Eui-myoung KIM, Hwaseong-si (KR)

Correspondence Address: CANTOR COLBURN, LLP, 20 Church Street, 22nd Floor, Hartford, CT, 06103, US

(73) Assignee: Electronics and Telecommunications Research Institute, Daejeon-city (KR)

(21) Appl. No.: 12/115,252

(22) Filed: May 5, 2008

(30) Foreign Application Priority Data
Dec. 17, 2007 (KR) 10-2007-0131963

(51) Int. Cl. G06K 9/52; G06K 9/00

(52) U.S. Cl. 382/154; 701/5

(57) ABSTRACT

Disclosed is a digital photogrammetric method and apparatus using the integrated modeling of different types of sensors. A unified triangulation method is provided for an overlapping area between an aerial image and a satellite image that are captured by a frame camera and a line camera equipped with different types of sensors. Ground control lines or ground control surfaces are used as ground control features used for the triangulation. A few ground control points may be used together with the ground control surface in order to further improve the three-dimensional position. The ground control line and the ground control surface may be extracted from LiDAR data. In addition, triangulation may be performed by bundle adjustment in the units of blocks each having several aerial images and satellite images. When an orthophoto is needed, it is possible to generate the orthophoto by appropriately using elevation models with various accuracies that are created by a LiDAR system, according to desired accuracy.

### BACKGROUND OF THE INVENTION

1. Field of the Invention

The present invention relates to a digital photogrammetric method and apparatus, and more particularly, to a digital photogrammetric method and apparatus using integrated modeling of different types of sensors that is capable of integrating images captured by different types of image capturing sensors to determine the three-dimensional positions of ground objects.

The invention is derived from researches conducted as a project of an IT core technology development plan of the Ministry of Information and Communication and the Institute for Information Technology Advancement [Project management No.: 2007-F-042-01, and Title: Technology Development for 3D GIS-based Wave Propagation Analysis].

2. Description of the Related Art

Digital photogrammetry is a technique for extracting 3D positional information of ground objects from image data acquired by cameras and applying a 3D elevation model to the extracted 3D positional information to finally generate orthophotos.

In particular, in recent years, aerial photogrammetry has drawn attention in order to effectively create a three-dimensional map. The aerial photogrammetry extracts 3D positional information of ground objects from satellite images or aerial images captured by cameras that are provided in a satellite or an airplane equipped with a GPS (global positioning system) or an INS (inertial navigation system).

In general, 3D positional information of ground objects are obtained by the specification of ground control points (GCP), orientation using the specified ground control points, and the geometric calculation of exterior orientation parameters calculated by the orientation.

A ground object that can be represented by one point on the map, such as a signpost, a streetlight, or a corner of a building, can be used as the ground control point. The three-dimensional coordinates of the ground control point are obtained by GPS measurement or photogrammetry.

The orientation is performed in the order of internal orientation and exterior orientation (relative orientation and absolute orientation), or in the order of internal orientation and aerotriangulation. Internal orientation parameters including the focal distance and principal point of a camera and the distortion of a lens are obtained by the internal orientation. The internal orientation is used to re-establish an internal optical environment of a camera, while the exterior orientation is used to define the positional relationship between a camera and an object. The exterior orientation is divided into relative orientation and absolute orientation according to the purpose of use.

The relative orientation defines the relative positions and poses of two aerial images having an overlapping area. The overlapping area between the two images is referred to as a “model”, and the reconfigured three-dimensional space is referred to as a “model space”. The relative orientation can be performed after the internal orientation, and enables the removal of vertical parallax of conjugate points as well as the acquisition of the position and pose of a camera in the model space.

A pair of photographs without vertical parallax removed by the relative orientation form a complete actual model. However, since this model defines the relative relationship between the two photographs with one of the two photographs being fixed, this model cannot represent topography with accurate scale and horizontality, which results in inaccurate similarity between actual topography and captured topography. Therefore, in order to match the model with the actual topography, it is necessary to transform a model coordinate system, which is a three-dimensional virtual coordinate system, into an object space coordinate system, which is called the absolute orientation. That is, the absolute orientation transforms a model space into a ground space using at least three ground control points having three-dimensional coordinates.

The exterior orientation determines six exterior orientation parameters required for a camera (sensor) model for aerial images. The six parameters includes coordinates (X, Y, Z) of the perspective center of the camera and rotation factors (pose) ω, φ, and κ with respect to a three-dimensional axis. Therefore, when a conjugate point of two images is observed, it is possible to obtain ground coordinates on the basis of the six exterior orientation parameters determined by the exterior orientation, by, for example, space intersection.

Meanwhile, at least two surface control points and three elevation control points are needed to measure the three-dimensional absolute coordinates of each point from a pair of overlapping photographs through the absolute orientation. Therefore, it is necessary to measure all the control points required, that is, all the ground control points, in order to accurately measure three-dimensional positions through the absolute orientation. However, when 3D position measurement is performed using a large number of aerial images, it requires a lot of time and costs to measure all the ground control points.

Therefore, a few ground control points are measured, and the coordinates of the other ground control points are determined by mathematical calculation using strip coordinates, model coordinates, or image coordinates of a precise coordinate measuring instrument, such as, a plotting instrument, which is called aerotriangulation. The aerotriangulation calculates exterior orientation parameters and the coordinates of an object space simultaneously, by using a method of least squares, through bundle adjustment.

Meanwhile, since the three-dimensional coordinates are calculated by the above-mentioned process on the assumption that the surface of the earth is disposed at a predetermined control altitude, an elevation model is applied to the three-dimensional coordinates to generate an orthophoto. The elevation model is in the form of data indicating the altitude information of a specific area, and represents, as numerical values, a variation in continuous undulation in a space on a lattice of an object area.

In the digital photogrammetry according to the related art, 3D positional information of ground objects is extracted from aerial images or satellite images that are captured by the same image capturing sensor (camera).

However, in recent years, with the development of optical technology, various types of image capturing sensors have captured images over various periods of time. For example, aerial images are captured by frame cameras, and satellite images are captured by line cameras, such as pushbroom sensors or whiskbroom sensors. Therefore, it is necessary to develop a new type of sensor modeling technique for integrating images captured by different types of image capturing sensors. In particular, a new sensor modeling technique needs to minimize the number of control points required to determine the position of a three-dimensional object, thereby improving the overall processing speed.

Further, in the determination of three-dimensional ground coordinates, the accuracy of ground control point data, which is used as ground control features, is lowered in a high-accuracy process, such as object recognition. In addition, most of the process of extracting points on the image corresponding to points on the ground is manually performed, but the extraction of two-dimensional or more object data, such as lines or surfaces, is more likely to be automated. In particular, it is possible to easily obtain a ground control line or a ground control surface by processing LiDAR (light detection and ranging) data that is increasingly used due to its high spatial accuracy. Therefore, it is necessary to develop a technique capable of automatically extracting three-dimensional objects from LIDAR data.

Furthermore, an elevation model according to the related art that is used to generate an orthophoto, which is a final outcome of a digital photogrammetric system, represents the surface of the earth in a simple form. However, the elevation model also has a spatial position error due to the spatial position error of the ground control points. Therefore, in the orthophoto that is finally generated, ortho-rectification is not sufficiently performed on the buildings or ground objects due to the influence of the elevation model, and thus the orthophoto has various space errors.

However, the LiDAR data can generate, for example, a DEM (digital elevation model), a DSM (digital surface model), and a DBM (digital building model) capable of accurately representing complicated ground structures since it has high accuracy and high point density. Therefore, it is necessary to develop a technique for creating precise and accurate orthophotos using the DEM, DSM, and DBM generated from the LiDAR data.

### SUMMARY OF THE INVENTION

An object of the invention is to provide a digital photogrammetric method and apparatus using the integrated modeling of different types of sensors that is capable of integrating images captured by different types of image capturing sensors, particularly, aerial images and satellite images to determine the three-dimensional positions of ground objects, and reducing or removing the number of ground control points required to determine the three-dimensional positions of ground objects.

Another object of the invention is to provide a digital photogrammetric method and apparatus using the integrated modeling of different types of sensors that can automatically and accurately determine the three-dimensional positions of ground objects on the basis of line data and surface data as well as point data.

Still another object of the invention is to provide a digital photogrammetric method and apparatus using the integrated modeling of different types of sensors that can use various types of elevation models for ortho-rectification according to accuracy required, thereby obtaining orthophotos with various accuracies.

According to an aspect of the invention, there is provided a digital photogrammetric method using integrated modeling of different types of sensors. The method includes: extracting ground control features indicating ground objects to be used to determine the spatial positions of the ground objects from geographic information data including information on the spatial positions of the ground objects; specifying image control features corresponding to the extracted ground control features, in space images captured by cameras having camera parameters that are completely or partially different with each other; establishing constraint equations from the geometric relationship between the ground control features and the image control features in an overlapping area between the space images; and calculating exterior orientation parameters of each of the space images using the constraint equations, and applying the exterior orientation parameters to the space images to determine the spatial positions of the ground objects.

According to another aspect of the invention, there is provided a digital photogrammetric apparatus using integrated modeling of different types of sensors. The apparatus includes: a control feature setting unit that extracts ground control lines or ground control surfaces that respectively indicate linear ground objects or planar ground objects to be used to determine the spatial positions of the ground objects from geographic information data including information on the spatial positions of the ground objects, and specifies image control lines or image control surfaces that respectively correspond to the extracted ground control lines or the extracted ground control surfaces, in space images including aerial images captured by a frame camera and satellite images captured by a line camera; and a spatial position measuring unit that groups the space images into blocks, establishes constraint equations from the geometric relationship between the ground control lines and the image control lines or the geometric relationship between the ground control surfaces and the image control surfaces, in the space images, and performs bundle adjustment on the constraint equations to determine exterior orientation parameters of each of the space images and the spatial positions of the ground objects.

As can be apparently seen from the experimental results, which will be described below, according to the above-mentioned aspects of the invention, it is possible to reduce or remove the number of ground control points required to determine the three-dimensional positions of ground objects. In particular, when ground control lines or ground control surfaces are extracted from LiDAR data, it is possible to further improve accuracy in determining the three-dimensional position.

Further, it is preferable to further extract ground control points indicating ground objects having point shapes as ground control features. In particular, as can be apparently seen from the experimental results, which will be described below, it is possible to further improve accuracy in determining the three-dimensional position by using both the ground control surface and a few ground control points.

Furthermore, the space images may be grouped into blocks, and the exterior orientation parameters and the spatial positions of the ground objects may be simultaneously determined by performing bundle adjustment on the space images in each of the blocks. According to this structure, as can be apparently seen from the experimental results, which will be described below, it is possible to considerably reduce the number of ground control points required.

Moreover, it is preferable to generate orthophotos with respect to the space images by ortho-rectification using at least one of a plurality of elevation models for different ground objects. The elevation model may include a DEM, a DSM, and a DBM created by a LiDAR system. The DEM is an elevation model representing the amplitude of the surface of the earth, the DSM is an elevation model representing the heights of all structures on the surface of the earth except for buildings, and the DBM is an elevation model representing the heights of buildings on the surface of the earth. According to this structure, it is possible to obtain orthophotos with various accuracies corresponding to required accuracies.

According to the invention, it is possible to integrate images captured by different types of image capturing sensors, particularly, aerial images and satellite images to determine the three-dimensional positions of ground objects. In addition, it is possible to reduce or remove the number of ground control points required to determine the three-dimensional positions of ground objects.

Further, it is possible to automatically and accurately determine the three-dimensional positions of ground objects on the basis of line data and surface data as well as point data.

Furthermore, it is possible to use various types of elevation models for ortho-rectification according to accuracy required, thereby obtaining orthophotos with various accuracies.

### BRIEF DESCRIPTION OF THE DRAWINGS

FIG. 1 is a block diagram illustrating the structure of a digital photogrammetric apparatus according to an embodiment of the invention;

FIG. 2 is a functional block diagram illustrating the apparatus shown in FIG. 1;

FIGS. 3A and 3B are diagrams illustrating the structure of image sensors of a frame camera and a line camera, respectively;

FIGS. 4A and 4B are diagrams illustrating a scene coordinate system and an image coordinate system of the line camera, respectively;

FIGS. 5A and 5B are diagrams illustrating the definition of a line in an image space and LiDAR, respectively;

FIG. 6 are diagrams illustrating the definition of a surface (patch) in an image space and LIDAR, respectively;

FIG. 7 is a conceptual diagram illustrating a coplanarity equation;

FIG. 8 is a conceptual diagram illustrating the coplanarity between image and LiDAR patches;

FIG. 9 is a diagram illustrating optical configuration for establishing data using planar patches as the source of control;

FIGS. 10A and 10B are diagrams illustrating a DSS middle image block and a corresponding LiDAR cloud, respectively;

FIG. 11 is a diagram illustrating an IKONOS scene coverage with three patches covered by LiDAR data and a DSS image; and

FIGS. 12A and 12B are diagrams illustrating orthophotos of an IKONOS image and a DSS image according to the embodiment of the invention and a captured image, respectively.

### DESCRIPTION OF THE PREFERRED EMBODIMENTS

The invention performs aerotriangulation by integrating an aerial image with a satellite image. The aerial image is mainly captured by a frame camera, and the satellite image is mainly captured by a line camera. The frame camera and the line camera are different from each other in at least some of the camera parameters including internal characteristics (internal orientation parameters) and external characteristics (exterior orientation parameters) of the camera. The invention provides a technique for integrating the frame camera and the line camera into a single aerotriangulation mechanism. In the specification, the aerial image and the satellite image are commonly referred to as a ‘space image’.

In the specification, embodiments of the invention, a mathematical principle used to implement the embodiments of the invention, and the results of experiments in the embodiments of the invention will be described in this order.

### 1. Embodiments

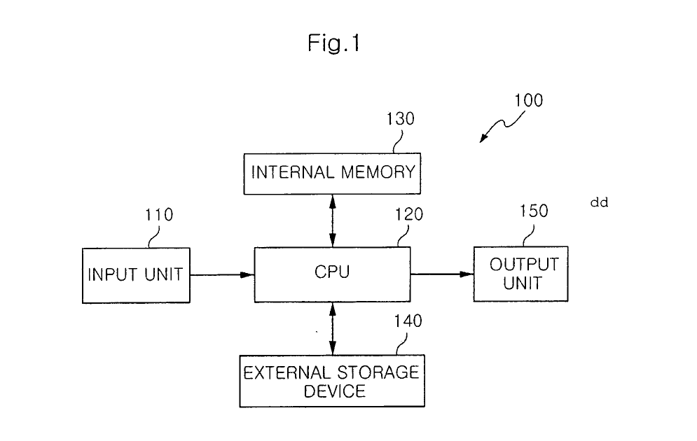

FIG. 1 is a block diagram illustrating the structure of a digital photogrammetric apparatus 100 using integrated modeling of different types of sensors according to an embodiment of the invention. In the specification, the term “integrated modeling of different types of sensors” means integrated triangulation of an overlapping region between the images captured by different types of sensors, such as the frame camera and the line camera.

The apparatus 100 includes an input unit 110, such as a mouse and a keyboard, that can input data used in this embodiment, a CPU 120 that performs the overall function of the invention on the basis of the data input through the input unit 110, an internal memory 130 that temporarily stores data required for a computing operation of the CPU 120, an external storage device 140, such as a hard disk, that stores a large amount of input data or output data, and an output unit 150, such as a monitor, that outputs the processed results of the CPU 120.

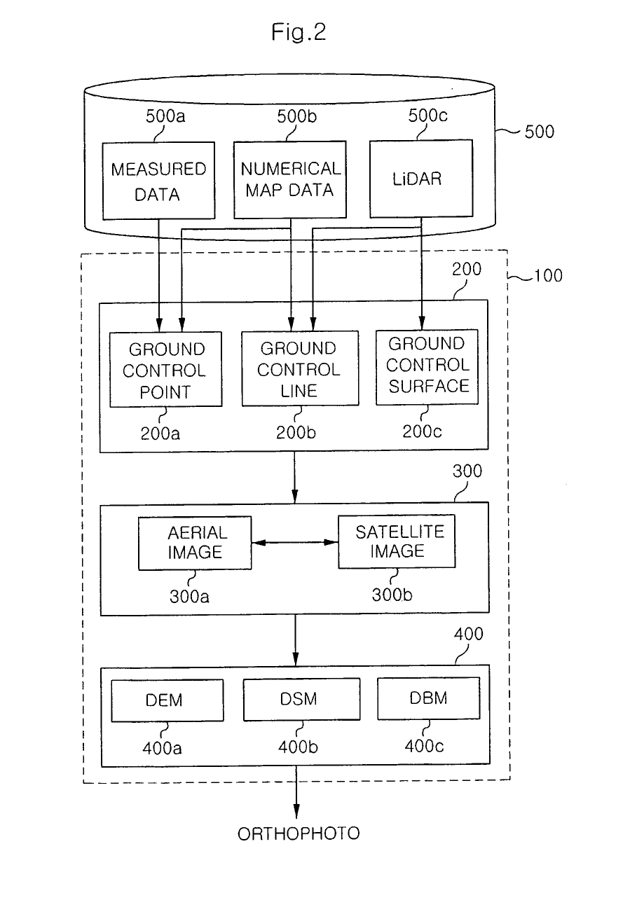

FIG. 2 is a functional block diagram illustrating the structure of the digital photogrammetric apparatus 100 shown in FIG. 1. The apparatus 100 includes a control feature setting unit 200 and a spatial position measuring unit 300, and may optionally include an orthophoto generating unit 400.

Meanwhile, in the integrated modeling of different types of sensors according to this embodiment, various data is used to acquire three-dimensional positional information of a ground object, which is a ground control feature. Therefore, a geographic information data storage unit 500 stores geographic information data that includes measured data 500a, numerical map data 500b, and LiDAR data 500c. The measured data 500a is positional information data of ground control points measured by a GPS. The numerical map data 500b is electronic map data obtained by digitizing data for various spatial positions of terrains and objects. The LiDAR data 500c is geographic information measured by a LiDAR system. The LiDAR system can generate an accurate terrain model using a method of calculating the distance to a ground object on the basis of the movement characteristics of laser pulses and the material characteristics of a ground object.

The control feature setting unit 200 extracts various ground control features, such as a ground control point 200a, a ground control line 200b, and a ground control surface 200c, from the geographic information data stored in the geographic information data storage unit 500, and specifies image control features in spatial images 300a and 300b corresponding to the extracted ground control features.

The ground control point 200a is an object that can be represented by a point on the ground, such as an edge of a building or a fountain, and can be extracted from the measured data 500a or the numerical map data 500b. The ground control line 200b is an object that can be represented by a line on the ground, such as the central line of the load or a river, and can be extracted from the numerical map data 500b or the LiDAR data 500c. The ground control surface 200c is an object that can be represented by a surface on the ground, such as a building or a playground, and can be extracted from the LiDAR data 500c. The image control features can be automatically specified by a known pattern matching method.

For example, when a LiDAR image that is represented by the LiDAR data 500c is displayed on a screen, a user designates a ground control line of the LiDAR image displayed on the screen. The control feature setting unit 200 extracts the ground control line designated by the user from the LiDAR data 500c, and automatically specifies an image control line corresponding to the extracted ground control line using a known pattern matching method. Therefore, the coordinates of the points forming the ground control line and the image control line are determined. The above-mentioned process is repeatedly performed on all input spatial images to specify control features.

When errors occur in the automatic specification of the image control feature beyond a permissible range and the user designates the image control feature having the errors again, the control feature setting unit 200 can specify the image control feature again. However, as described above, since the line feature or the surface feature is more likely to be automatically specified than the point feature, the automatic specification of the image control feature using the line feature or the surface feature can avoid most of the errors.

The spatial position measuring unit 300 performs aerotriangulation on an overlapping region between the spatial images 300a and 300b to calculate exterior orientation parameters, and determines the three-dimensional positions of ground objects corresponding to the image objects in the spatial images. As will be described in detail later, limitations, such as collinearity equations and coplanarity equations, are applied to the image coordinates of the image control feature and the ground coordinates of the ground control feature to perform aerotriangulation.

In the aerotriangulation, a plurality of spatial images are grouped into blocks, and bundle adjustment is performed on each block to calculate an exterior orientation parameter and the coordinates of an object space (that is, the three-dimensional coordinates of a ground space) using a method of least squares. In experiments which will be described below, triangulation is performed on three aerial image blocks, each having six aerial images, and a stereo pair of satellite images. The experiments prove that triangulation using the integration of the aerial image blocks and the stereo pair of satellite images can considerably reduce the number of ground control points, as compared to triangulation using only the stereo pair of satellite images.

The orthophoto generating unit 400 applies a predetermined digital elevation model to the coordinates of an object space calculated by the spatial position measuring unit 300 to generate an orthophoto, if necessary. In particular, a DEM, a DSM, and a DBM obtained from LiDAR data can be used, if necessary. In this embodiment, a DEM 400a is an elevation model that represents only the altitude of the surface of the earth. In addition, in this embodiment, a DSM 400b is an elevation model that represents the heights of all objects on the surface of the earth, such as trees and structures, except for buildings. Further, in this embodiment, a DBM 400c is an elevation model that includes information on the heights of all buildings on the surface of the earth. Therefore, it is possible to generate various orthophotos with different accuracies and precisions.

For example, an orthophoto of level 1 is obtained by performing ortho-rectification using only the DEM 400a, on the basis of a geographical variation. An orthophoto of level 2 is obtained by performing ortho-rectification using both the DEM 400a and the DSM 400b, on the basis of the heights of all the objects on the surface of the earth, except for building, as well as the geographical variation. An orthophoto of level 3 is obtained by performing ortho-rectification using all of the DEM 400a, the DSM 400b, and the DBM 400c, in consideration of geographic displacement and the heights of all objects including buildings on the surface of the earth. Therefore, the orthophoto of level 3 has the highest accuracy and precision, followed by the orthophoto of level 2 and the orthophoto of level 1.

Meanwhile, the digital photogrammetric method according to this embodiment is implemented by executing the functions of the digital photogrammetric apparatus shown in FIGS. 1 and 2 according to each step. That is, the digital photogrammetric method according to this embodiment includes: a step of extracting a ground control feature; a step of specifying an image control feature corresponding to the extracted ground control feature; and a step of performing aerotriangulation on an overlapping area between the spatial images, and may optionally include a step of generating an orthophoto.

Further, the invention can be applied to a computer readable recording medium including a program for executing the method. It will be apparently understood by those skilled in the art that the above-described embodiment is specified by the detailed structure and drawings, but the embodiment does not limit the scope of the invention. Therefore, it will be understood that the invention include various modifications that can be made without departing from the spirit and scope of the invention, and equivalents thereof.

### 2. Photogrammetric Principles

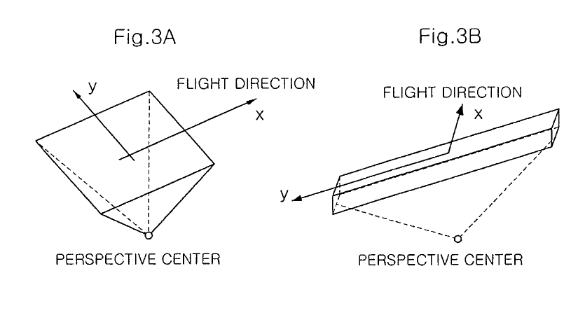

FIG. 3A shows the structure of an image sensor of the frame camera, and FIG. 3B shows the structure of an image sensor of the line camera. As shown in FIGS. 3A and 3B, the frame camera has a two-dimensional sensor array, but the line camera has a single linear sensor array on a focal plane. A single exposure of the linear sensor array covers a narrow strip in the object space. Therefore, in order to capture contiguous areas on the ground using the line camera, the image sensor should be moved while leaving the shutter open. In this regard, a distinction is made between a ‘scene’ and an ‘image’.

The ‘image’ is obtained through a single exposure of an optical sensor in the focal plane. The ‘scene’ covers a two-dimensional area of the object space and may be composed of one or more images depending on the property of the camera. According to this distinction, a scene captured by the frame camera is composed of a single image, whereas a scene captured by the line camera is composed of a plurality of images.

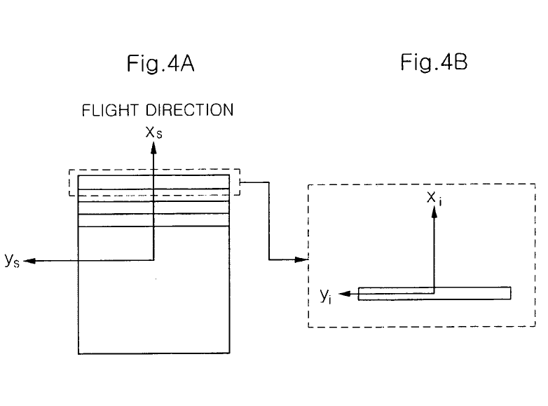

Similar to the frame camera, the line camera satisfies the collinearity equations that the perspective center, points on the image, and the corresponding object points are aligned on a straight line. The collinearity equation of the line camera can be represented by Expression 1. The collinearity equations represented by Expression 1 include the image coordinates (xᵢ, yᵢ), which are equivalent to the scene coordinates (xₛ, yₛ), when dealing with the scene captured by the frame camera. For line cameras, however, the scene coordinates (xₛ, yₛ) need to be transformed into image coordinates. In this case, the value of xₛ is used to indicate the moment of exposure of the corresponding image. On the other hand, the value of yₛ is directly related to the yᵢ image coordinate (see FIG. 4). The xᵢ image coordinate in Expression 1 is a constant which depends on the alignment of the linear sensor array in the focal plane:

$$\begin{matrix}{x}_{i} = {x}_{p} - c \frac{{r}_{1 \; 1}^{t} ( {X}_{G} - {X}_{O}^{t} ) + {r}_{21}^{t} ( {Y}_{G} - {Y}_{O}^{t} ) + {r}_{31}^{t} ( {Z}_{G} - {Z}_{O}^{t} )}{{r}_{13}^{t} ( {X}_{G} - {X}_{O}^{t} ) + {r}_{23}^{t} ( {Y}_{G} - {Y}_{O}^{t} ) + {r}_{33}^{t} ( {Z}_{G} - {Z}_{O}^{t} )} , \\ {y}_{i} = {y}_{p} - c \frac{{r}_{1 \; 2}^{t} ( {X}_{G} - {X}_{O}^{t} ) + {r}_{22}^{t} ( {Y}_{G} - {Y}_{O}^{t} ) + {r}_{32}^{t} ( {Z}_{G} - {Z}_{O}^{t} )}{{r}_{13}^{t} ( {X}_{G} - {X}_{O}^{t} ) + {r}_{23}^{t} ( {Y}_{G} - {Y}_{O}^{t} ) + {r}_{33}^{t} ( {Z}_{G} - {Z}_{O}^{t} )} ,\end{matrix} \qquad [ Expression 1 ]$$

(where (X_{G}, Y_{G}, Z_{G}) are the ground coordinates of an object point, (X^{t}ₒ, Y^{t}ₒ, Z^{t}ₒ) are the ground coordinates of the perspective center at an exposure time t, r₁₁′ to r₃₃′ are the elements of a rotation matrix at the moment of exposure, (xᵢ, yᵢ) are the image coordinates of a point under consideration, and (xₚ, yₚ, c) are the interior orientation parameters (IOPs) of the image sensor. That is, xₚ and yₚ are the image coordinates of the principal point, and c is the focal distance).

The collinearity equations of the frame and line cameras are different from each other in that the frame camera captures an image by a single exposure, but the line camera captures a scene by multiple exposures. Therefore, the exterior orientation parameters (EOPs) associated with a line camera scene are time dependent and vary depending on the image considered within the scene. This means that each image has an unknown exterior orientation parameter and an excessively large number of unknown exterior orientation parameters are included in the entire scene. For practical reasons, the bundle adjustment of the scenes captured by line cameras does not consider all the involved exterior orientation parameters. This is because an excessively larger number of parameters require an extensive amount of time and effort.

In order to reduce the number of exterior orientation parameters related to the line camera, the following two methods are used: a method of modeling a system trajectory using a polynomial and an orientation image method.

The method of modeling a system trajectory using a polynomial determines a variation in EOPs with time. The degree of the polynomial depends on the smoothness of the trajectory. However, this method has problems in that the flight trajectory is too rough to be represented by the polynomial and it is difficult to combine values observed by GPS and INS. Therefore, the orientation image method is the better way to reduce the number of EOPs.

The orientation images are generally designated at equal distances along the system trajectory. The EOPs of the image captured at any given time are modeled as a weighted average of EOPs of adjacent images, that is, so-called orientation images.

Meanwhile, the imaging geometry associated with line cameras includes the reduction methodology of the involved EOPs and is more general than that of frame cameras. In other words, the imaging geometry of a frame camera can be derived as a special case of that of a line camera. For example, an image captured by a frame camera can be considered a special case of a scene captured by a line camera in which the trajectory and attitude are represented by a zero-order polynomial. Alternatively, when working with orientation images, a frame image can be considered a line camera scene with one orientation image. The general nature of the imaging geometry of line cameras lends itself to straightforward development of multi-sensor triangulation procedures capable of incorporating frame and line cameras.

### 3. Triangulation Primitive

The accuracy of triangulation relies on the identification of common primitives that associate the datasets involved with a reference frame defined by control information. The term ‘common primitives’ means a ground control feature of an overlapping area between two images and image control feature corresponding thereto. Traditionally, photogrammetric triangulation has been based on the ground control points, that is, point primitives. However, LiDAR data consists of discontinuous and irregular footprints, in contrast to photogrammetric data, which is acquired from continuous and regular scanning of the object space. Considering the characteristics of photogrammetric data and LIDAR data, relating a LIDAR footprint to the corresponding point in imagery is almost impossible. Therefore, the point primitives are not suitable for the LiDAR data, but, as described above, line primitives and surface primitives are suitable to relate LiDAR data and photogrammetric data as control lines and control surfaces.

Line features can be directly identified (specified) in imagery, while conjugate LiDAR lines can be extracted through planar patch segmentation and intersection. Alternatively, LiDAR lines can be directly identified in the laser intensity images produced by most of today's LiDAR systems. However, line features extracted by the planar patch segmentation and intersection are more accurate than the features extracted from intensity images. Other than line features, areal primitives in photogrammetric datasets can be defined using their boundaries, which can be identified in the imagery. The areal primitives include, for example, rooftops, lakes, and other homogeneous regions. In the LiDAR dataset, areal regions can be derived through planar patch segmentation techniques.

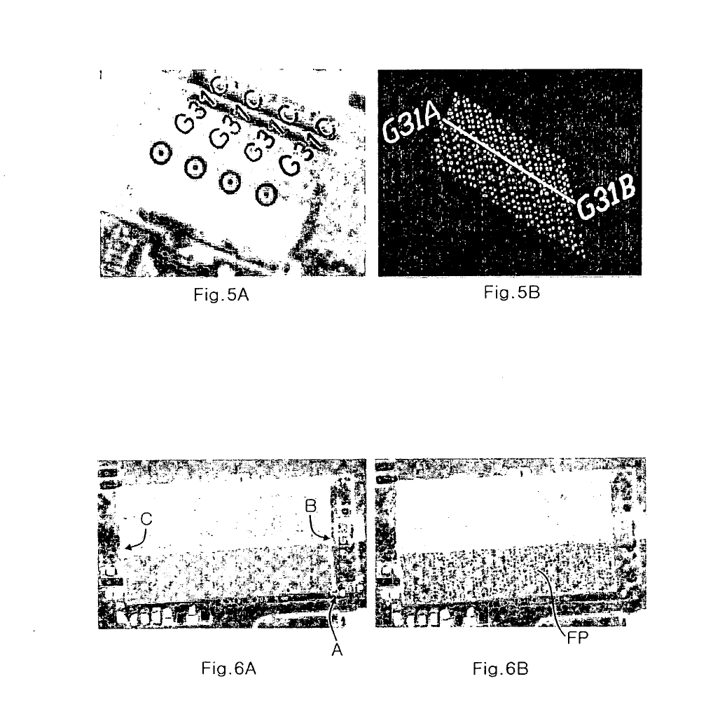

Another issue related to primitive selection is their representation in both photogrammetric and LiDAR data. In this regard, image space lines can be represented by a sequence of image points (G31C) along the corresponding line feature (see FIG. 5A). This is an appealing representation since it can handle image space line features in the presence of distortions which cause deviations from straightness in the image space. Moreover, such a representation allows the extraction of line features from scenes captured by line cameras, since perturbations in the flight trajectory lead to deviations from straightness in the image space line features corresponding to object space straight lines. The intermediate points selected along corresponding line segments in overlapping scenes need not be conjugate. In the LiDAR data, object lines can be represented by their end points (G31A and G31B) (see FIG. 5B). The points defining the LiDAR line need not be visible in the imagery.

Meanwhile, when using the areal primitives, planar patches in the photogrammetric dataset can be represented by three points, that is, three corner points (A, B, and C) (see FIG. 6A). These points should be identified in all overlapping images. Like the line features, this representation is valid for scenes captured by frame and line cameras. On the other hand, LiDAR patches can be represented by the footprints FP defining that patch (see FIG. 6B). These points can be derived directly using planar patch segmentation techniques.

### 4. Constraint Equations

4.1. Utilizing Straight Linear Primitives

This subsection focuses on deriving the mathematical constraint for relating LiDAR lines and photogrammetric lines, which are represented by the end points in the object space and a sequence of intermediate points in the image space, respectively.

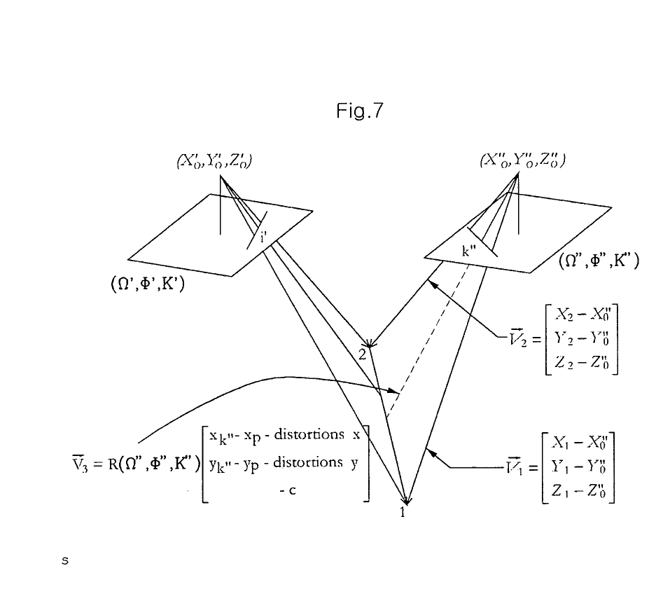

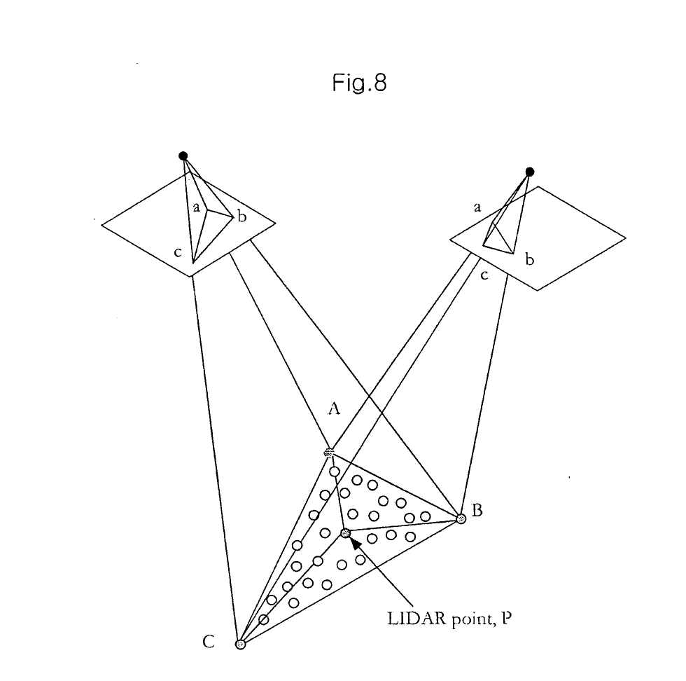

The photogrammetric datasets are aligned with a LiDAR reference frame through direct incorporation of LiDAR lines as the source of control. The photogrammetric and LiDAR measurements along corresponding lines can be related to each other through the coplanarity equation represented by Expression 2 given below. The coplanarity equation indicates that a vector from the perspective center (Xₒ″, Yₒ″, Zₒ″) to any intermediate image point (X_{k′″}, Y_{k″}, 0) along the image line is included in the plane that is defined by the perspective center of the image and two points (X₁, Y₁, Z₁) and (X₂, Y₂, Z₂) defining the LiDAR line. That is, for a given intermediate point k″, points {(X₁, Y₁, Z₁), (X₂, Y₂, Z₂), (Xₒ″, Yₒ″, Zₒ″), and (x_{k″}, Y_{k″}, 0)} are coplanar (see FIG. 7).

(\vec{V}₁×\vec{V}₂)·\vec{V}₃=0,

(where, V1 is a vector connecting the perspective center to the first end point of the LiDAR line, V2 is a vector connecting the perspective center to the second end point of the LiDAR line, and V3 is a vector connecting the perspective center to an intermediate point of the corresponding image line).

For the intermediate image point, the coplanarity equation represented by Expression 2 is combined with the collinearity equation represented by Expression 1, and the combination is used for bundle adjustment.

The constraint equation is applied to all the intermediate points along the line features in the image space. For scenes captured by line cameras, the involved EOPs should correspond to the image associated with the intermediate points under consideration. For frame cameras with known IOPs, a maximum of two independent constraints can be defined for a given image. However, in self-calibration procedures, additional constraints help in the recovery of the IOPs since the distortion pattern will change from one intermediate point to the next intermediate point along the line feature in the image space. On the other hand, the coplanarity equation helps in better recovery of the EOPs associated with line cameras. Such a contribution is attributed to the fact that the system's trajectory will affect the shape of the line feature in the image space.

For an image block, at least two non-coplanar line segments are needed to establish data of the reconstructed object space, that is, the scale, rotation, and shift components. Such a requirement assumes that a model can be derived from the image block and is explained by the fact that a single line defines two shift components across the line as well as two rotation angles. Another non-coplanar line helps in estimating the remaining shift and rotation components as well as the scale factor.

4.2. Utilizing Planar Patches

This subsection focuses on deriving the mathematical constraint for relating LiDAR and photogrammetric patches, which are represented by a set of points in the object space and three points in the image space, respectively. As an example, it is considered a surface patch which is represented by two sets of points, that is, a photogrammetric set S_{PH}={A, B, C} and a LiDAR set S_{L}={(Xₚ, Yₚ, Zₚ), P=1 to n} (see FIG. 8).

Since the LiDAR points are randomly distributed, no point-to-point correspondence can be assumed between datasets. For the photogrammetric points, the image and object space coordinates are related to each other through the collinearity equations. On the other hand, LiDAR points belonging to a specific planar surface should be matched with the photogrammetric patch representing the same object space surface (see FIG. 8). The coplanarity of the LiDAR and photogrammetric points can be mathematically expressed by Expression 3 given below:

$$V = \vert \begin{matrix}{X}_{P} & {Y}_{P} & {Z}_{P} & 1 \\ {X}_{A} & {Y}_{A} & {Z}_{A} & 1 \\ {X}_{B} & {Y}_{B} & {Z}_{B} & 1 \\ {X}_{C} & {Y}_{C} & {Z}_{C} & 1\end{matrix} \vert = \vert \begin{matrix}{X}_{P} - {X}_{A} & {Y}_{P} - {Y}_{A} & {Z}_{P} - {Z}_{A} \\ {X}_{B} - {X}_{A} & {Y}_{B} - {Y}_{A} & {Z}_{B} - {Z}_{A} \\ {X}_{C} - {X}_{A} & {Y}_{C} - {Y}_{A} & {Z}_{C} - {Z}_{A}\end{matrix} \vert = 0. \qquad [ Expression 3 ]$$

The above constraint is used as a constraint equation for incorporating LiDAR points into the photogrammetric triangulation. In physical terms, this constraint means that the normal distance between any LiDAR point and the corresponding photogrammetric surface should be zero, that is, the volume of the tetrahedron composed of the four points is zero. This constraint is applied to all LiDAR points forming the surface patch. The above constraint is valid for both the frame and line cameras. For the photogrammetric point, the constraint equation represented by Expression 3 is combined with the collinearity equation represented by Expression 1, and the combination is used for bundle adjustment.

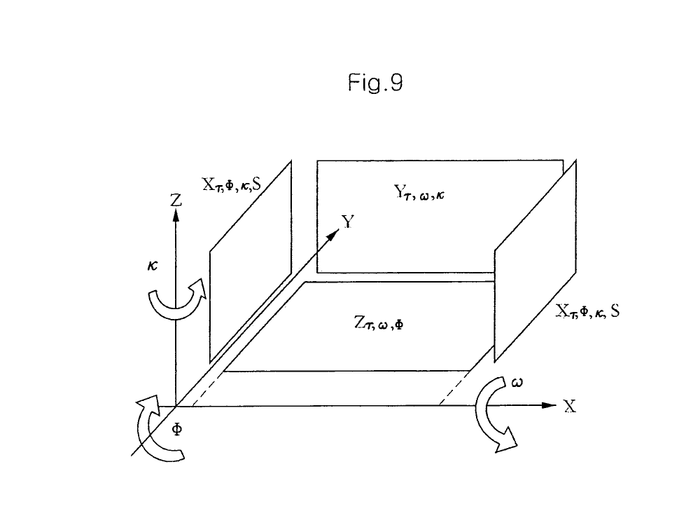

To be sufficient as the only source of control, LiDAR patches should be able to provide all the data parameters, that is, three translations (X_{T}, Y_{T}, Z_{T}), three rotations (ω, φ, κ), and one scale factor S. FIG. 9 shows that a patch orthogonal to one of the axes will provide the shift in the direction of that axis as well as the rotation angles across the other axes. Therefore, three non-parallel patches are sufficient to determine the position and orientation components of a piece of data. For scale determination, three planar patches should not intersect at a single point (for example, facets of a pyramid). Alternatively, the scale can be determined by incorporating a fourth plane, as shown in FIG. 9. However, the probability of having vertical patches in airborne LiDAR data is not high. Therefore, tilted patches with varying slopes and aspects can be used, instead of the vertical patches.

### 5. Experimental Results

The conducted experiments involved a digital frame camera equipped with a GPS receiver, a satellite-based line camera, and a LiDAR system. These experiments investigated the following issues:
The validity of using a line-based geo-referencing procedure for scenes captured by the frame and line cameras;
The validity of using a patch-based geo-referencing procedure for scenes captured by the frame and line cameras; and
The impact of integrating satellite scenes, aerial scenes, LiDAR data, and GPS positions of the exposures in a unified bundle adjustment procedure.

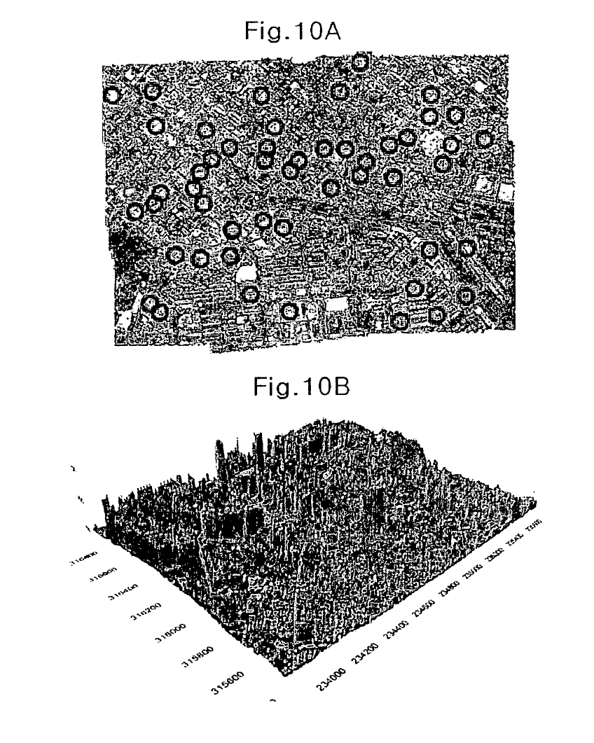

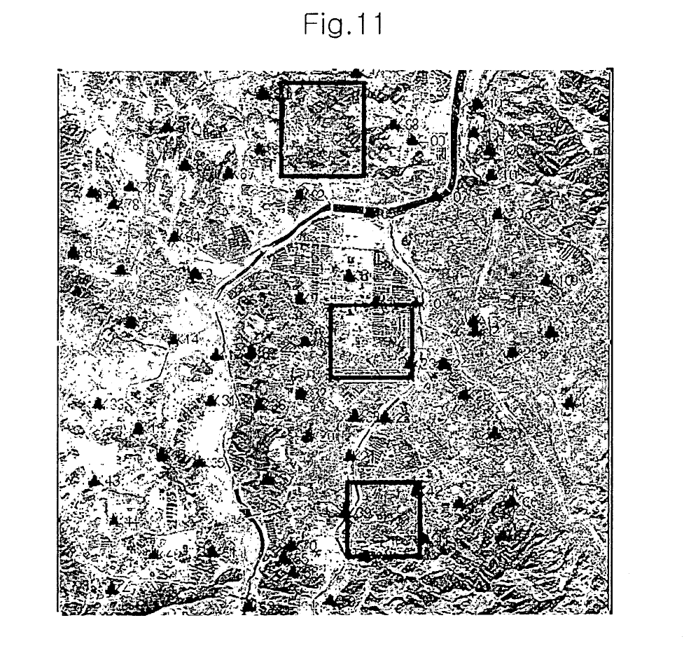

A first dataset includes three blocks of 6-frame digital images captured in April 2005, by the Applanix Digital Sensor System (DSS) over the city of Daejeon in South Korea, from an altitude of 1500 m. The DSS camera had 16 mega pixels (9 μm pixel size) and a 55 mm focal length. The position of the DSS camera was tracked using a GPS receiver provided therein. The second dataset consisted of an IKONOS stereo-pair, which was captured in November 2001, over the same area. It should be noted that these scenes were raw imagery that did not go through any geometric correction and were provided for research purposes. Finally, a multi-strip LiDAR coverage corresponding to the DSS coverage was collected using the OPTECH ALTM 3070 with an average point density of 2.67 point/m², from an altitude of 975 m. An example of one of the DSS image blocks and a visualization of the corresponding LiDAR coverage are shown in FIGS. 10A and 10B. FIG. 11 shows the IKONOS coverage and the location of the DSS image blocks (represented by rectangles).

To extract the LiDAR control feature, a total of 139 planar patches with different slopes and aspects and 138 line features were manually identified through planar patch segmentation and intersection. FIGS. 10A and 10B show the locations (which are represented by small circles in FIG. 10A) of the features extracted from a middle LiDAR point cloud (FIG. 10B) within the IKONOS scenes. The corresponding line and areal features were digitized in the DSS and IKONOS scenes. To evaluate the performance of the different geo-referencing techniques, a set of 70 ground control points was also acquired. The distribution of these points (small triangular points) is shown in FIG. 11.

The performances of the point-based, line-based, patch-based, and GPS-assisted geo-referencing techniques are assessed using root mean square error (RMSE) analysis. In the different experiments, some of the available ground control points were used as control features in the bundle adjustment, while the other points were used as check points.

To investigate the performances of the various geo-referencing methods, the inventors conducted the following experiments:
Photogrammetric triangulation of the IKONOS scenes while varying the number of ground control points used (the second column in Table 1);
Photogrammetric triangulation of the IKONOS and DSS scenes while varying the number of ground control points used (the third column in Table 1);
Photogrammetric triangulation of the IKONOS and DSS scenes while considering the GPS observations associated with the DSS exposures and varying the number of ground control points used (the fourth column in Table 1);
Photogrammetric triangulation of the IKONOS and DSS scenes while varying the number of LiDAR lines (45 and 138 lines) together with changing the number of ground control points (the fifth and sixth columns in Table 1); and
Photogrammetric triangulation of the IKONOS and DSS scenes while varying the number of LiDAR patches (45 and 139 patches) together with changing the number of ground control points (the seventh and eighth columns in Table 1).

The results of the experiments are shown in Table 1 given below:

TABLE 1

| | IKONOS | | | | | | |
|---|---|---|---|---|---|---|---|
| | only | IKONOS + 188 DSS frame images | | | | | |
| | Ground | Ground | | Control points plus | | | |
| Number | control | control | | Control | | Control | |
| of | points | points | DSS | lines | | patches | |
| GCPs | only | only | GPS | 138 | 45 | 139 | 45 |
| 0 | N/A | N/S | 3.1 | 3.1 | 3.1 | 5.4 | 5.9 |
| 1 | N/A | N/S | 3.4 | 3.0 | 3.1 | 5.4 | 6.4 |
| 2 | N/A | N/S | 3.1 | 3.1 | 3.2 | 4.8 | 5.2 |
| 3 | N/A | 21.3 | 2.9 | 2.9 | 2.8 | 2.9 | 3.1 |
| 4 | N/A | 20.0 | 2.8 | 2.7 | 2.8 | 2.6 | 3.1 |
| 5 | N/A | 4.3 | 2.7 | 2.7 | 2.7 | 2.6 | 2.7 |
| 6 | 3.7 | 3.4 | 2.8 | 2.7 | 2.7 | 2.6 | 2.7 |
| 7 | 3.9 | 3.0 | 2.6 | 2.7 | 2.7 | 2.5 | 2.6 |
| 8 | 3.6 | 3.4 | 2.6 | 2.6 | 2.5 | 2.5 | 2.7 |
| 9 | 4.1 | 2.5 | 2.5 | 2.6 | 2.5 | 2.4 | 2.5 |
| 10 | 3.1 | 2.5 | 2.5 | 2.6 | 2.5 | 2.4 | 2.5 |
| 15 | 3.2 | 2.4 | 2.5 | 2.5 | 2.4 | 2.4 | 2.4 |
| 40 | 2.0 | 2.1 | 2.1 | 2.1 | 2.1 | 2.0 | 2.0 |

In Table 1, the “N/A” means that no solution was attainable, that is, the provided control feature was not sufficient to establish data necessary for the triangulation procedure. Table 1 shows the following results:
When only the ground control points are used as control features for triangulation, the stereo IKONOS scene require a minimum of six ground control points (the second column in Table 1);
When triangulation includes DSS imagery together with the IKONOS scenes, the control requirement for convergence is reduced to three ground control points (the third column in Table 1). Moreover, the incorporation of the GPS observations at the DSS exposure station enables convergence without the need for any ground control point (the fourth column in Table 1). Therefore, it is clear that incorporating satellite scenes with a few frame images enables photogrammetric reconstruction while reducing the number of ground control points; and

The LiDAR linear features are sufficient for geo-referencing the IKONOS and DSS scenes without the need for any additional control features. The fifth and sixth columns in Table 1 show that incorporating additional control points in the triangulation procedure does not significantly improve the reconstruction outcome. Moreover, the fifth and sixth columns show that increasing the line features from 45 to 138 does not significantly improve the quality of the triangulation outcome.

Meanwhile, the LiDAR patches are sufficient for geo-referencing the IKONOS and DSS scenes without the need for an additional control feature (the seventh and eighth columns in Table 1). However, the seventh and eighth columns of Table 1 show that incorporating a few control points significantly improves the results. For example, when 3 ground control points and 139 control patches are used, RMSE is reduced from 5.4 m to 2.9 m. Incorporating additional control points (four or more ground control points) do not have a significant impact. The improvement in the reconstruction outcome as a result of using a few ground control points can be attributed to the fact that the majority of the utilized patches are horizontal with gentle slopes, as they represent building roofs. Therefore, the estimation of the model shifts in the X and Y directions is not accurate enough. Incorporating vertical or steep patches can solve this problem. However, such patches are not available in the provided dataset. Moreover, comparison of the seventh and eighths columns of Table 1 shows that increasing the number of control patches from 45 to 139 do not significantly improve the result of the triangulation.

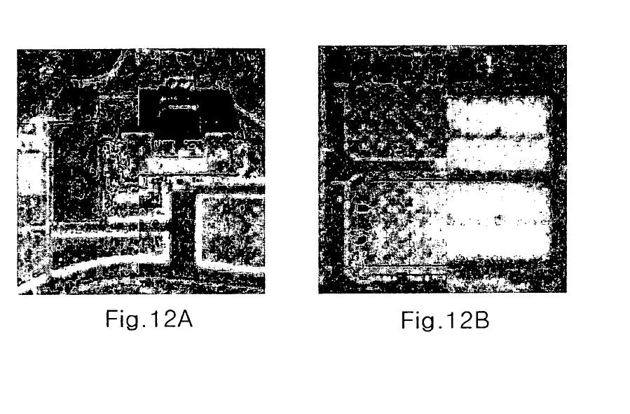

The comparison between different geo-referencing techniques demonstrates that the patch-based, line-based, and GPS-assisted geo-referencing techniques result in better outcomes than point-based geo-referencing. Such an improvement demonstrates the benefit of adopting multi-sensor and multi-primitive triangulation procedures. In an additional experiment, the inventors utilize the EOPs derived from the multi-sensor triangulation of the frame and line camera scenes together with the LIDAR surface to generate orthophotos. FIGS. 12A and 12B show sample patches, in which the IKONOS and DSS orthophotos are laid side by side. As seen in FIG. 12A, the generated orthophotos are quite compatible, as demonstrated by the smooth continuity of the observed features between the DSS and IKONOS orthophotos. FIG. 12B shows object space changes between the moments of capture of the IKONOS and DSS imagery. Therefore, it is evident that multi-sensor triangulation of imagery from frame and line cameras improves accuracy in positioning the derived object space while offering an environment for accurate geo-referencing of the temporal imagery.

What is claimed is:

1. A digital photogrammetric method comprising:
extracting ground control features indicating ground objects to be used to determine the spatial positions of the ground objects from geographic information data including information on the spatial positions of the ground objects;
specifying image control features corresponding to the extracted ground control features, in space images captured by cameras having completely or partially different camera parameters with each other;
establishing constraint equations from the geometric relationship between the ground control features and the image control features in an overlapping area between the space images; and
calculating exterior orientation parameters of each of the space images using the constraint equations, and applying the exterior orientation parameters to the space images to determine the spatial positions of the ground objects.

2. The digital photogrammetric method of claim 1,
wherein the ground control feature is a ground control line indicating a linear ground object or a ground control surface indicating a planar ground object, and
the image control feature is an image control line or an image control surface corresponding to the ground control line or the ground control surface, respectively.

3. The digital photogrammetric method of claim 2,
wherein, in the establishment of the constraint equations, when the ground control feature is the ground control line, the constraint equation is established from the geometric relationship in which both end points of the ground control line, the perspective center of the space image, and an intermediate point of the image control line are coplanar.

4. The digital photogrammetric method of claim 2,
wherein, in the establishment of the constraint equations, when the ground control feature is the ground control surface, the constraint equation is established from the geometric relationship in which the normal distance between a point included in the ground control surface and the image control surface is zero.

5. The digital photogrammetric method of claim 2,
wherein the ground control feature and the image control feature further include a ground control point indicating a ground object having a point shape and an image control point corresponding to the ground control point, and
in the establishment of the constraint equations, collinearity equations is further established as the constraint equations, derived from the geometric relationship in which the perspective center of the space image, the image control point, and the ground control point are collinear.

6. The digital photogrammetric method of claim 2,
wherein the geographic information data includes LiDAR data, and
in the extraction of the ground control features, the ground control features are extracted from the LiDAR data.

7. The digital photogrammetric method of claim 1,
wherein the determining of the spatial positions of the ground objects includes:
grouping the space images into blocks; and
performing bundle adjustment on the groups of the space images to simultaneously determine the spatial positions of the ground objects and the exterior orientation parameters.

8. The digital photogrammetric method of claim 1, further comprising:
generating orthophotos with respect to the space images by ortho-rectification using at least one of a plurality of elevation models.

9. The digital photogrammetric method of claim 8,
wherein the elevation model includes a DEM, a DSM, and a DBM created by a LIDAR system,
the DEM is an elevation model representing the altitude of the surface of the earth,
the DSM is an elevation model representing the heights of all structures on the surface of the earth except for buildings, and
the DBM is an elevation model representing the heights of buildings on the surface of the earth.

10. The digital photogrammetric method of claim 1,
wherein the space images include aerial images captured by a frame camera provided in an airplane and satellite images captured by a line camera provided in a satellite.

11. A digital photogrammetric apparatus comprising:
a control feature setting unit that extracts, from geographic information data including information on the spatial positions of the ground objects, ground control lines or ground control surfaces that respectively indicate linear ground objects or planar ground objects to be used to determine the spatial positions of the ground objects, and specifies image control lines or image control surfaces that respectively correspond to the extracted ground control lines or the extracted ground control surfaces, in space images including aerial images captured by a frame camera and satellite images captured by a line camera; and
a spatial position measuring unit that groups the space images into blocks, establishes constraint equations from the geometric relationship between the ground control lines and the image control lines or the geometric relationship between the ground control surfaces and the image control surfaces, in the space images, and performs bundle adjustment on the constraint equations to determine exterior orientation parameters of each of the space images and the spatial positions of the ground objects.

12. The digital photogrammetric apparatus of claim 11,
wherein the control feature setting unit extracts the ground control surfaces and specifies the image control surfaces, and further extracts ground control points indicating ground objects having point shapes and further specifies image control points corresponding to the ground control points, and
the spatial position measuring unit establishes the constraint equations for the ground control surfaces from the geometric relationship in which the normal distance between a point included in the image control surface and the ground control surface is zero, and further establishes, as the constraint equations, collinearity equations derived from the geometric relationship in which the perspective center of the space image, the image control point, and the ground control point are collinear.

13. The digital photogrammetric apparatus of claim 11,
wherein the geographic information data includes LiDAR data, and
the control feature setting unit extracts the ground control lines or the ground control surfaces from the LiDAR data.

14. The digital photogrammetric apparatus of claim 11, further comprising:
an orthophoto generating unit that generates orthophotos with respect to the space images by ortho-rectification using at least one of a plurality of elevation models for different ground objects.

15. The digital photogrammetric apparatus of claim 11, further comprising:
an orthophoto image generating unit that generates orthophotos with respect to the space images by ortho-rectification using at least one of a DEM, a DSM, and a DBM created by a LiDAR system,
wherein the DEM is an elevation model representing the altitude of the surface of the earth,
the DSM is an elevation model representing the heights of all structures on the surface of the earth except for buildings, and
the DBM is an elevation model representing the heights of buildings on the surface of the earth.
